(19) United States
(12) Patent Application Publication
(10) Pub. No.: US 2008/0319571 A1
(43) Pub. Date: Dec. 25, 2008

(54) Method and Device for Controlling and Regulating a Hollow Body Manufacturing Unit

(75) Inventors: Klaus Voth, Obertraubling-piesenkofen (DE); Andreas Brunner, Aufhausen (DE); Erik Blochmann, Neutraubling (DE); Florian Geltinger, Neufahrn (DE); Florian Schmid, Ihlerstein (DE)

Correspondence Address: MARSHALL, GERSTEIN & BORUN LLP, 233 S. WACKER DRIVE, SUITE 6300, SEARS TOWER, CHICAGO, IL, 60606, US

(73) Assignee: KRONES AG, NEUTRAUBLING (DE)

(21) Appl. No.: 12/065,997

(22) PCT Filed: Aug. 18, 2006
(86) PCT No.: PCT/EP2006/008154

§ 371 Date: Jul. 3, 2008

(30) Foreign Application Priority Data
Sep. 8, 2005 (DE) 10 2005 042 926.2

(51) Int. Cl. B29C 49/12; B29C 49/00

(52) U.S. Cl. 700/197

(57) ABSTRACT

A method for controlling and regulating a unit for producing hollow bodies, including a compressor, a blowing machine and a control unit, which controls both the compressor and the blowing machine. A system also provided for returning blast air from the finished blown container to the compressor. Also, a device for producing hollow bodies, with a compressor, a blowing machine and a control system, which for the exchange of data is connected to the blowing machine and to the compressor.

### CROSS-REFERENCE TO RELATED APPLICATION

The present application claims the benefit of priority of International Patent Application No. PCT/EP2006/008154, filed on Aug. 18, 2006, which application claims priority of German Patent Application No. 10 2005 042 926.2, filed Sep. 8, 2005. The entire text of the priority application is incorporated herein by reference in its entirety.

### FIELD OF THE DISCLOSURE

The disclosure relates to a method for controlling and regulating a hollow body manufacturing unit and a device for manufacturing hollow bodies, such as used in forming containers for bottling operations.

### BACKGROUND

Such hollow body manufacturing units are used in various branches of the industry, e.g., in the glass and plastics industries. Glass bottles are produced by this method in the glass industry, for example. Such machine units are used for the manufacture of hollow bodies, in particular containers such as bottles, in the plastics industry. Previously heated bottle parisons or preforms are placed in molds where they are treated with compressed air and thereby receive their final shape. These machines always have control devices and sometimes also have regulating devices to ensure the most optimum possible container quality at the highest possible production rates.

According to the state of the art, hollow body manufacturing units having control units are known, such that the control unit is responsible only for controlling the hollow body manufacturing machine. The compressors which supply the compressed air for manufacturing the hollow bodies run at a constant power, but it does not matter whether a container is to be manufactured with a maximal pressure (e.g., 40 bar) or at a lower pressure (e.g., 32 bar). The pressure is not regulated via the compressor but instead by a pressure reduction in the hollow body manufacturing machine.

In addition, there are known hollow body manufacturing units in the state of the art, in which the hollow body manufacturing machine and the compressor both have their own control units. If container production in the hollow body manufacturing machine is reset and/or retooled, the control unit of this and the control unit of the compressor are reset separately from one another.

One problem with this type of equipment is that the labor involved in resetting the production is very high because several control units must be operated. It is a problem in particular when there are multiple container manufacturing machines and multiple compressors that must be reset in parallel. This may be the case, for example, when multiple compressors are connected to one container manufacturing machine, when one compressor supplies multiple container manufacturing machines or when a block of multiple compressors supplies a block of multiple container manufacturing machines.

### SUMMARY OF THE DISCLOSURE

The object of the present disclosure is therefore to provide a method and a device with which it is readily possible to perform a production change-over in hollow body manufacturing units by a simple method. Furthermore, another object of the present disclosure is to make available a more efficient and simpler method of manufacturing hollow bodies and/or to make available a simpler and more efficient machine.

To do so, both a compressor and a hollow body manufacturing machine in a hollow body manufacturing unit are controlled with one control unit. A hollow body manufacturing machine may be a glass bottle manufacturing machine or a plastic container manufacturing machine. These are preferably machines for manufacturing PET containers, in particular PET bottles, in which case the machine is a carousel stretch blow molding machine according to a preferred refinement of the present invention. A linear machine is of course also conceivable.

The hollow body manufacturing unit preferably consists of a compressor, a stretch blow molding machine and a control unit, which is connected to the stretch blow molding machine and also to the compressor. It is also within the scope of the present invention for multiple stretch blow molding machines to be connected to one compressor, for multiple compressors to be connected to one stretch blow molding machine and for multiple stretch blow molding machines to be connected to multiple compressors. All these variants have in common the fact that they are controlled and/or regulated by a shared central control unit.

It does not matter where the control unit is located. The control unit may be accommodated in and/or on the stretch blow molding machine just as equally as it may be accommodated in and/or on the compressor or in a separate control cabinet.

In a stretch blow molding machine, parisons are usually heated briefly before processing and are then introduced into a blow mold, where they are pre-blown to completion with blow molding air under pressure in a first step and then are completed in a second step. According to a preferred embodiment of the disclosure, the blow molding air from the finished blow molded container is recirculated back to the compressor, and this recirculation may be accomplished in various ways. For example, it is possible to introduce the recirculated blow molding air flow upstream from the compressor, so that it can be combined with the air taken in by the compressor. Introduction of the blow molding air downstream from the compressor so that two compressed air flows are combined is also conceivable. If a multistage compressor is used, it is also conceivable to introduce the recirculated air flow between two compressor stages. When using compressors, it is completely irrelevant which type is used. Piston compressors may be used as well as screw compressors, Roots blowers, combinations thereof or other types, depending on the application.

Recirculating the blow molding air to an intermediate storage and from there back to the compressor is possible to equalize certain unwanted fluctuations in pressure. In the application of the method, it is irrelevant whether all the blow molding air is recirculated from the blow molding process or only a portion thereof.

According to another preferred embodiment of the disclosure, the recirculation of the blow molding air to the compressor is controlled by the control unit. This is preferably accomplished as a function of the operating situation of the stretch blow molding machine. This means that the control unit specifies recirculation times of different lengths, depending on the pressure level in the blow molded containers, for example. This has the advantage that the control unit can therefore take the middle path between optimal air recirculation and optimal process time. The term “operating situation” is also understood to refer to the amount of blow molding air available in the completely blow molded container. For example, this yields the constellation whereby the control unit does not perform recirculation despite the stipulation by the machine operating personnel that recirculation of the blow molding air to the compressor is desired; this will occur, for example, when the volume of the completely blow molded container is below a certain threshold level.

According to another embodiment of the disclosure, the control of the compressor is implemented by input of parameters pertaining to the compressor into the control unit. Direct control of the compressor via the control unit is also possible.

Preferably however the compressor is not controlled directly but instead indirectly. To do so, the parameters pertaining to the stretch blow molding machine are entered via the control unit, retrieving the corresponding programs or program parts that pertain to the compressor. Such parameters which implement the control of a compressor indirectly may include, for example, the pre-blowing pressure, the finished blow molding pressure, the production output of the stretch blow molding machine, the container volume or the readiness for air recirculation to the compressor. In other words, by entering a value for the finished blow molding pressure in the container into the control unit, for example, a program that stipulates a certain setpoint power to be made available to the compressor is retrieved. The values forwarded to the blow molding machine via the control unit may be any desired values, and certain settings and/or criteria are thereby relayed to the compressor.

According to another preferred embodiment of the disclosure, the actual power of the compressor is regulated by the processing of measured values by the control unit. Such a measured value may be, for example, the pressure in the return line from a blow molding station to the compressor. Due to this fact, the power of the compressor can be adapted even more accurately to the true power conditions prevailing in the blow molding machine. With joint control, it is thus possible to optimally coordinate a blow molding machine and a compressor (or multiple blow molding machines and/or multiple compressors) and their connected units so that the consumption of blow molding media and/or power is optimized.

Especially in embodiments having multiple compressors and/or multiple blow molding machines, it is not advisable to connect the individual units to the central unit by cable but instead a wireless data exchange should be implemented. Such wireless communication may be accomplished, e.g., by using the Bluetooth standard, infrared, microwaves or other electromagnetic waves.

It is self-evident that the hollow body manufacturing unit may consist not only of a blow molding machine, a compressor and a control unit but such a unit may also include other components such as sensors, conveyor lines, valves and others.

According to a preferred embodiment of the disclosure, the control unit is a programmable control system.

A control unit for data exchange is connected to the stretch blow molding machine and also to the compressor. According to a preferred embodiment of the disclosure, the data exchange takes place bidirectionally.

The hollow body manufacturing machine preferably has a pneumatic return line leading to the compressor. It is irrelevant for the embodiments and/or refinements whether the return line opens directly into the compressor and/or between the various stages of the compressor or whether it opens upstream from the compressor, i.e., into its air intake area or downstream from the compressor, i.e., into its compressed air delivery area.

The hollow body manufacturing machine is preferably a stretch blow molding machine for plastic bottles, in particular PET bottles, such that a stretch blow molding machine of the revolving design is preferred for use here.

In addition a further embodiment of the disclosure consists of the fact that the central control unit is situated in the blow molding machine but it is also possible to accommodate it in the compressor. The control unit has an input device by means of which the parameters can be input and settings can be adjusted. According to another embodiment of the disclosure, the input device is a touch screen. Other input devices such as switches, buttons or other keypads are also feasible.

Another preferred embodiment of the disclosure consists of the fact that the control unit is situated in the blow molding machine and the input device is situated on the blow molding machine. As an alternative, it is also possible to accommodate the control unit in a separate control cabinet or to accommodate it in the compressor.

The compressor(s), the control unit and the one or more blow molding machines are preferably equipped with modules for wireless data exchange such that these modules may be, e.g., Bluetooth, infrared, microwave or other electromagnetic transmitting and receiving units.

### BRIEF DESCRIPTION OF THE DRAWINGS

A concrete embodiment of the disclosure will now be explained in greater detail on the basis of the FIGURE, in which

FIG. 1 shows a schematic diagram of a unit having a blow molding machine, a compressor and a control unit.

### DETAILED DESCRIPTION OF THE PREFERRED EMBODIMENTS

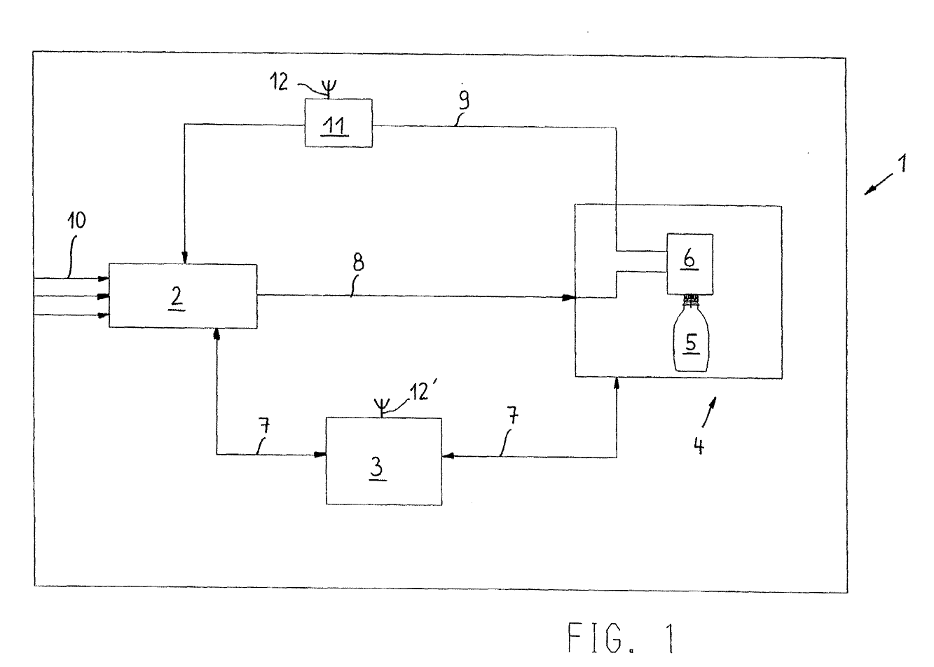

FIG. 1 shows a compressor 2 which is connected to a blow molding machine 4 via an air supply 8 and an air recirculation 9. The compressor 2 has an air intake 10 through which filtered fresh air is taken in and compressed. The compressed air is sent via the air supply 8 to the blow molding machine 4 where the supply is accomplished via a ring duct (not shown here) and a blowing jet 6 to the container 5. This container is blow molded from a parison to the finished container 5 in at least two blow molding phases, namely a pre-blowing phase and a main blow molding phase. When blow molding of the container 5 is finished, the blow molding air can be recirculated back to the compressor 2 again from the container via the blowing jet 6 and the air recirculation 9.

A control unit 3 which is connected via a bidirectional signal transmission 7 to the blow molding machine 4 and the compressor 2 assumes the control of the aforementioned processes. Therefore, all the functions of the connected machines can be retrieved, checked and modified via the control unit 3.

The air recirculation 9 is equipped with a pressure sensor 11 which monitors the pressure conditions of the blow molding air to be recirculated out of the container 5. This data is sent from the pressure sensor 11 to the transmitting and receiving unit 12 of the control unit 3 via a transmitting/receiving unit 12′ by wireless transmission. With the help of these results as well as other results, the control unit 3 is able to optimally regulate the compressor 2 in order to optimize and/or reduce the power consumption by the entire hollow body manufacturing unit 1. One possibility for controlling and regulating the compressor 2 is by controlling and regulating the power.

1. Method for controlling and regulating a hollow body manufacturing unit (1), comprising at least one compressor (2), at least one hollow body manufacturing machine (4), at least one control unit (3), both the compressor (2) and the hollow body manufacturing machine (4) being controlled with the control unit (3).

2. Method according to claim 1, wherein blow molding air is recirculated from the hollow body manufacturing machine (4) to the compressor (2).

3. Method according to claim 2, wherein the recirculation of the blow molding air back to the compressor (2) is controlled by the control unit (3) as a function of an operating situation of the hollow body manufacturing machine (4).

4. Method according to claim 2, wherein the recirculation of the blow molding air to the compressor (2) is controlled by the control unit (3) as a function of an amount of blow molding air available in the completely blow molded hollow body (5).

5. Method according to claim 1, wherein the control of the compressor (2) is implemented by input of parameters with regard to the compressor (2) into the control unit (3).

6. Method according to claim 1, wherein the control of the compressor (2) is implemented by input of parameters with respect to the hollow body manufacturing machine (4) into the control unit and the resulting retrieval of one of the programs and program parts assigned to these parameters with regard to the settings of the compressor (2).

7. Method according to claim 1, wherein the setpoint power of the compressor (2) is preselected by input of parameters into the control unit (3) pertaining to the hollow body manufacturing machine (4).

8. Method according to claim 7, wherein the actual power of the compressor is regulated through the processing of measured values which are recorded in the hollow body manufacturing unit (1).

9. Method according to claim 8, wherein the actual power of the compressor (2) is regulated by processing the value of the actual pressure prevailing in a recirculation line (9) which returns the blow molding air from the blow molding station to the compressor (2).

10. Method according to claim 7, wherein the parameters used include one of the pre-blowing pressure, the finished blow molding pressure, the production output of the hollow body manufacturing machine (4), the size of the hollow body, and the readiness for recirculation of air back to the compressor, and combinations thereof.

11. Method according to claim 1, wherein at least one stretch blow molding machine for bottles is used in the hollow body manufacturing unit (1).

12. Method according to claim 1, wherein there is data exchange by the control unit (3) to the components of the hollow body manufacturing unit (1), with the date exchange being performed wirelessly.

13. Device for manufacturing hollow bodies (5), comprising at least one compressor (2), at least one hollow body blow molding machine (4), at least one control unit (3) for providing a data exchange, and the control unit (3) being connected to both the hollow body blow molding machine (4) and the compressor (2) for the data exchange.

14. Device according to claim 13, wherein the data exchange is performed bidirectionally.

15. Device according to claim 14, wherein the hollow body manufacturing machine is pneumatically connected to the compressor (2) by a recirculation line (9).

16. Device according to claim 13, the hollow body manufacturing device (4) being a stretch blow molding machine (4) for plastic bottles (5).

17. Device according to claim 16, wherein the stretch blow molding machine (4) is a machine of a revolving design.

18. Device according to claim 13, wherein the control unit (3) is in the stretch blow molding machine (4).

19. Device according to claim 13, wherein the control unit (3) is in the compressor (2).

20. Device according to claim 13, wherein the control unit (3) has an input device by means of which the parameters can be input and settings can be performed.

21. Device according to claim 20, wherein the input device is a touch screen.

22. Device according to claim 13, wherein the control unit (3) is located in the stretch blow molding machine (4) and the input unit is located in the stretch blow molding machine (4).

23. Device according to claim 13, wherein one of the control unit (3), the blow molding machine (4), the compressor (2), a pressure sensor (11), and combinations thereof is equipped with modules for wireless data exchange.

24. Device for manufacturing hollow bodies (5) according to claim 13, wherein the compressor is a multistage compressor and the hollow body manufacturing machine (4) is pneumatically connected to the compressor (2) by a recirculation line (9).

25. Device according to claim 24, wherein the blow molding air recirculated by the recirculation line (9) is inserted between two compressor stages.

26. Method for controlling and regulating a hollow body manufacturing unit (1), comprising:
providing a device for manufacturing hollow bodies according to claim 13,
forming the at least one compressor as a multistage compressor, and
recirculating the blow molding air from the hollow body manufacturing machine (4) back to the compressor (2).

27. Method according to claim 26, and introducing the recirculated blow molding air between two compressor stages of the compressor (2).

28. Device according to claim 16, wherein the plastic bottles are PET bottles.
